(19) United States
(12) Patent Application Publication
(10) Pub. No.: US 2011/0076226 A1
(43) Pub. Date: Mar. 31, 2011

(54) Base-facilitated production of hydrogen from biomass

(76) Inventors: Benjamin Reichman, West Bloomfield, MI (US); William Mays, Commerce, MI (US)

(21) Appl. No.: 12/804,188

(22) Filed: Jul. 15, 2010

Related U.S. Application Data
(63) Continuation of application No. 10/966,001, filed on Oct. 14, 2004, now abandoned.
Application No. 10/966,001 is a continuation-in-part of application No. 10/763,616, filed on Jan. 23, 2004, now Pat. No. 7,481,992.
Application No. 10/763,616 is a continuation-in-part of application No. 10/636,093, filed on Aug. 7, 2003, now Pat. No. 6,994,839.
Application No. 10/636,093 is a continuation-in-part of application No. 10/321,935, filed on Dec. 17, 2002, now Pat. No. 6,890,419.
Application No. 10/321,935 is a continuation-in-part of application No. 09/929,940, filed on Aug. 15, 2001, now Pat. No. 6,607,707.
Application No. 10/636,093 is a continuation-in-part of application No. 09/929,940, filed on Aug. 15, 2001, now Pat. No. 6,607,707.
Application No. 09/929,940 is a continuation-in-part of application No. 09/929,940, filed on Aug. 15, 2001, now Pat. No. 6,607,707.

(51) Int. Cl. C01B 3/02

(52) U.S. Cl. 423/648.1

(57) ABSTRACT

Hydrogen is produced from a reaction of organic matter with a base. A bicarbonate or carbonate compound forms as a by-product. The base-facilitated hydrogen-producing reactions are thermodynamically more spontaneous than conventional-type reformation reactions and are able to produce hydrogen gas at less extreme reaction conditions than conventional-type reformation reactions. The preferred reactants are biomass, components of biomass, and mixtures of components of biomass. Especially preferred are base-facilitated reactions in which hydrogen is produced from carbohydrates or mixtures of carbohydrates, include monosaccharides, disaccharides, polysaccharides, and cellulose. The instant reactions can occur in the liquid phase or solid.

### CROSS-REFERENCE TO RELATED APPLICATIONS

This application is a continuation of U.S. application Ser. No. 10/966,001; which is a continuation-in-part of U.S. patent application Ser. No. 10/763,616 (now U.S. Pat. No. 7,481,992); which in turn is a continuation-in-part of both U.S. patent application Ser. No. 10/636,093 (now U.S. Pat. No. 6,994,839) and U.S. patent application Ser. No. 10/321,935 (now U.S. Pat. No. 6,890,419), each of which is a continuation-in-part of U.S. patent application Ser. No. 09/929,940 (now U.S. Pat. No. 6,607,707) the disclosures of which are all herein incorporated by reference.

### FIELD OF INVENTION

This invention relates to processes for forming hydrogen gas. More particularly, this invention relates to the production of hydrogen gas from organic substances through chemical reactions under alkaline conditions. Most particularly, the instant invention relates to the production of hydrogen gas through reactions of naturally occurring organic matter in the presence of a base.

### BACKGROUND OF THE INVENTION

Modern societies are critically dependent on energy derived from fossil fuels to maintain their standard of living. As more societies modernize and existing modern societies expand, the consumption of fossil fuels continues to increase and the growing dependence worldwide on the use of fossil fuels is leading to a number of problems. First, fossil fuels are a finite resource and concern is growing that fossil fuels will become fully depleted in the foreseeable future. Scarcity raises the possibility that escalating costs could destabilize economies as well as the likelihood that nations will go to war over the remaining reserves. Second, fossil fuels are highly polluting. The greater combustion of fossil fuels has prompted recognition of global warming and the dangers it poses to the stability of the earth's ecosystem. In addition to greenhouse gases, the combustion of fossil fuels produces soot and other pollutants that are injurious to humans and animals. In order to prevent the increasingly deleterious effects of fossil fuels, new energy sources are needed.

The desired attributes of a new fuel or energy source include low cost, plentiful supply, renewability, safety, and environmental compatibility. Hydrogen is currently a promising prospect for providing these attributes and offers the potential to greatly reduce our dependence on conventional fossil fuels. Hydrogen is the most ubiquitous element in the universe and, if its potential can be realized, offers an inexhaustible fuel source to meet the increasing energy demands of the world. Hydrogen is available from a variety of sources including natural gas, hydrocarbons in general, organic materials, inorganic hydrides and water. These sources are geographically well distributed around the world and accessible to most of the world's population without the need to import. In addition to being plentiful and widely available, hydrogen is also a clean fuel source. Combustion of hydrogen produces water as a by-product. Utilization of hydrogen as a fuel source thus avoids the unwanted generation of the carbon and nitrogen based greenhouse gases that are responsible for global warming as well as the unwanted production of soot and other carbon based pollutants in industrial manufacturing.

The realization of hydrogen as a ubiquitous source of energy ultimately depends on its economic feasibility. Economically viable methods for producing hydrogen as well as efficient means for storing, transferring, and consuming hydrogen, are needed. Chemical and electrochemical methods have been proposed for the production of hydrogen. The most readily available chemical feedstocks for hydrogen are organic compounds, primarily hydrocarbons and oxygenated hydrocarbons. Common methods for obtaining hydrogen from hydrocarbons and oxygenated hydrocarbons are dehydrogenation reactions and oxidation reactions.

Steam reformation and the electrochemical generation of hydrogen from water through electrolysis are two common strategies currently used for producing hydrogen. Both strategies, however, suffer from drawbacks that limit their practical application and/or cost effectiveness. Steam reformation reactions are endothermic at room temperature and generally require temperatures of several hundred degrees to achieve acceptable reaction rates. These temperatures are costly to provide, impose special requirements on the materials used to construct the reactors, and limit the range of applications. Steam reformation reactions also occur in the gas phase, which means that hydrogen must be recovered from a mixture of gases through a separation process that adds cost and complexity to the reformation process. Steam reformation also leads to the production of the undesirable greenhouse gases CO₂ and/or CO as by-products. Water electrolysis has not been widely used in practice because high expenditures of electrical energy are required to effect water electrolysis. The water electrolysis reaction requires a high minimum voltage to initiate and an even higher voltage to achieve practical rates of hydrogen production. The high voltage leads to high electrical energy costs for the water electrolysis reaction and has inhibited its widespread use.

In U.S. Pat. No. 6,607,707 (the '707 patent), the disclosure of which is incorporated by reference herein, the instant inventors considered the production of hydrogen from hydrocarbons and oxygenated hydrocarbons through reactions of hydrocarbons and oxygenated hydrocarbons with a base. Using a thermodynamic analysis, the instant inventors determined that reactions of many hydrocarbons and oxygenated hydrocarbons react spontaneously with a base or basic aqueous solution to form hydrogen gas at particular reaction conditions, while the same hydrocarbons and oxygenated hydrocarbons react non-spontaneously in conventional steam reformation processes at the same reaction conditions. Inclusion of a base was thus shown to facilitate the formation of hydrogen from many hydrocarbons and oxygenated hydrocarbons and enabled the production of hydrogen at less extreme conditions than those normally encountered in steam reformation reactions, thereby improving the cost effectiveness of producing hydrogen gas. In many reactions, the processes of the '707 patent led to the formation of hydrogen gas from a liquid phase reaction mixture, in some cases at room temperature, where hydrogen was the only gaseous product and thus was readily recoverable without the need for a gas phase separation step. The reactions of the '707 patent further operate through the formation of carbonate ion or bicarbonate ion and avoid the production of the greenhouse gases CO and CO₂. Inclusion of a base creates a new reaction pathway for the formation of hydrogen gas with thermodynamic benefits that allow for the production of hydrogen gas at lower temperatures than are needed for corresponding steam reformation processes.

In co-pending U.S. patent application Ser. No. 10/321,935 (the '935 application), published as U.S. Pat. Appl. Pub. No. 2003/0089620, the disclosure of which is incorporated by reference herein, the instant inventors considered electrochemical methods to promote the production of hydrogen from organic substances in the presence of water (or acidic solution) and/or a base. They showed that electrochemical reactions of organic substances with water to produce hydrogen require lower electrochemical cell voltages than water electrolysis. They also showed that electrochemical reactions of organic substances in the presence of an acid or base require low electrochemical cell voltages at room temperature.

In co-pending U.S. patent application Ser. No. 10/636,093 (the '093 application), published as U.S. Pat. Appl. Pub. No. 2004/0028603, the disclosure of which is incorporated by reference herein, the instant inventors recognized that the realization of the beneficial properties of the reactions described in the '707 patent and the co-pending '935 application requires a system level consideration of the costs and overall efficiency of the reactions. In addition to energy inputs and raw materials, consideration of the disposal or utilization of by-products must be made. Of particular importance is consideration of the dispensation of the carbonate and bicarbonate ion products of the disclosed hydrogen producing reactions. In the co-pending '093 application, the instant inventors describe strategies for the recycling of the carbonate and bicarbonate ions. A carbonate recycle process was described that includes a first step in which carbonate ion is reacted with a metal hydroxide to form a soluble metal hydroxide and a weakly soluble or insoluble carbonate salt. The soluble metal hydroxide may be returned to the hydrogen producing reaction as a base reactant for further production of hydrogen. In a second step, the carbonate salt is thermally decomposed to produce a metal oxide and carbon dioxide. In a third step, the metal oxide is reacted with water to reform the metal hydroxide used in the first step. The carbonate recycle process is thus sustainable with respect to the metal hydroxide and the overall hydrogen producing process is sustainable with respect to the base through the carbonate recycling process of the '093 application. Bicarbonate by-products of hydrogen producing reactions of organic substances with bases can be similarly recycled according to the '093 application by first converting a bicarbonate by-product to a carbonate and then recycling the carbonate.

In co-pending U.S. patent application Ser. No. 10/763,616 (the '616 application), published as U.S. Pat. Appl. Pub. No. 2004/0156777, the disclosure of which is incorporated by reference herein, the instant inventors described an extension of the base-facilitated production of hydrogen from organic substances to a wider range of starting materials. Of particular importance in the '616 application was the production of hydrogen from petroleum-related or petroleum-derived starting materials such as long chain hydrocarbons; fuels such as gasoline, kerosene, diesel, petroleum distillates and components thereof; and mixtures of organic substances.

The hydrogen producing reactions of the '707 patent and the '935 and '616 applications provide for an efficient, environmentally friendly method for generating the hydrogen needed for the advancement of a hydrogen based economy. There is a need to further extend the range of applicability of the hydrogen producing reactions beyond what was described in the earlier patents and co-pending applications. Of particular interest is consideration of the range of starting materials that may be used in the reactions and the suitability of commonly available organic substances for use as reactants. Also of interest is the range of viable reaction conditions that are conducive to the formation of hydrogen gas and optimization of reaction conditions with respect to trade-offs that may be present between reaction efficiency, reaction rate and process cost.

### SUMMARY OF THE INVENTION

The instant invention provides a process for producing hydrogen gas from chemical or electrochemical reactions of organic substances or mixtures thereof derived from biomass with bases in which carbonate and/or bicarbonate compounds are produced as a by-product. The instant process optionally includes a carbonate or bicarbonate recycle process in which the carbonate or bicarbonate by-product is transformed to a base that can subsequently be further reacted with an organic substance or mixture thereof to produce hydrogen gas.

The instant base-facilitated hydrogen-producing reactions improve the thermodynamic spontaneity of producing hydrogen gas from biomass, a component thereof, or mixtures of components thereof relative to the production of hydrogen gas through the corresponding conventional reformation. In one embodiment, the greater thermodynamic spontaneity permits the production of hydrogen gas through the instant base-facilitated reactions of an organic substance or mixtures thereof from or derived from biomass at temperatures that are lower than those needed to produce hydrogen gas from the organic substance or mixtures thereof in a conventional reformation reaction. In another embodiment, the greater thermodynamic spontaneity permits the production of hydrogen gas from an organic substance or mixtures thereof from or derived from biomass at a faster rate at a particular temperature in a base-facilitated reaction than in a conventional reformation reaction of the organic substance or mixture thereof at the particular temperature.

In a preferred embodiment, hydrogen is produced from reactions of biomass, components thereof or mixtures of components thereof with a base in a chemical or electrochemical reaction. The preferred biomass materials and components include carbohydrates, monosaccharides, disaccharides, polysaccharides, cellulose, and oxidized or reduced forms thereof. The instant base-facilitated reactions permit the production of hydrogen from biomass at lower temperatures or faster rates relative to conventional reformation reactions of biomass, components thereof or mixtures of components thereof.

In one embodiment, the instant base-facilitated hydrogen production reactions are completed in a solution or liquid phase using a soluble or partially soluble base as a reactant along with soluble or partially soluble biomass or soluble or partially soluble components thereof. In another embodiment, the instant base-facilitated reactions are completed between solid phase biomass or biomass component(s) and a solid phase base. In yet another embodiment, the instant base-facilitated reactions are completed between solid phase biomass or biomass component(s) and a solid phase base in the presence of vapor phase water.

### BRIEF DESCRIPTION OF THE DRAWINGS

FIG. 1. Pressure as a function of time in a reaction of glucose with sodium hydroxide in water in an embodiment according to the instant invention.

### DETAILED DESCRIPTION OF THE ILLUSTRATED EMBODIMENTS

The instant invention is concerned with an extension of the chemical and electrochemical hydrogen-producing reactions described in U.S. Pat. No. 6,607,707 (the '707 patent), U.S. patent application Ser. No. 10/321,935 (the '935 application), and U.S. patent application Ser. No. 10/763,616 (the '616 application), the disclosures of which are incorporated by reference herein. The instant invention in particular provides for the production of hydrogen from additional organic substances and mixtures of organic substances. In a preferred embodiment, hydrogen is produced from naturally recurring or renewable organic matter in a base-facilitated reformation reaction that proceeds through a carbonate or bicarbonate by-product compound. The carbonate or bicarbonate by-product may include the carbonate or bicarbonate ion as a product in liquid phase solution or may include a carbonate or bicarbonate salt in the solid phase.

The hydrogen producing reactions of the instant invention include the reaction of naturally occurring organic matter with a base. In a preferred embodiment, the organic matter is biomass. Biomass is a general term used to refer to all non-fossil organic materials that have an intrinsic chemical energy content. Biomass includes organic plant matter, vegetation, trees, grasses, aquatic plants, wood, fibers, animal wastes, municipal wastes, crops and any matter containing photosynthetically-fixed carbon. Biomass is available on a renewable or recurring basis and is thus much more readily replenished than fossil fuels. The volume of biomass available makes it the only other naturally-occurring carbon resource that is sufficiently plentiful to substitute for fossil fuels. It is estimated that the standing renewable biomass available in the world today for use as an energy resource is about 100 times the world's total annual energy consumption.

Biomass is currently being tested for various applications that traditionally use fossil fuels. Biopower generation is a process that converts non-fossil fuel derived organic matter into electricity. Biomass is also used to produce alternative fuels known as biofuels (e.g. biodiesel) that can be used to power vehicles and engines. One advantage associated with biomass is that it can be stored and consumed as needed to provide power on demand. As a result, in contrast to intermittent sources such as wind and solar, energy can be produced from biomass in a steady and predictable manner.

The capture of solar energy through photosynthesis drives the formation of biomass. During photosynthesis, the organic compounds that make up biomass are produced from CO₂ and H₂O in the presence of light. The principle compounds present in biomass are carbohydrates. Glucose (C₆H₁₂O₆) is a representative carbohydrate found in biomass and is formed in photosynthesis through the reaction:

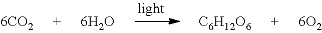

In the instant invention, biomass or a component of biomass is organic matter that is utilized as a feedstock or starting material in a base-facilitated hydrogen-producing reaction. As discussed in the '707 patent, the '935 application and '616 application, reactions of organic substances with a base permit the production of hydrogen gas through the formation of carbonate ion and/or bicarbonate by-products. Inclusion of a base as a reactant in the production of hydrogen from organic substances thus provides an alternative reaction pathway relative to conventional reformation reactions of organic substances, which proceed through a reaction pathway that leads to the production of CO₂ from a reaction of an organic substance with water.

The alternative reaction pathway of the instant base-facilitated reformation reactions of organic matter leads to a more spontaneous (or less non-spontaneous) reaction at a particular set of reaction conditions relative to a conventional reformation reaction of the same organic matter. For illustration purposes, a comparative example involving an oxygenated hydrocarbon from the '707 patent may be considered. The production of hydrogen from ethanol may occur through the following reactions (1), (2) or (3) in the standard state liquid phase:

| | | ΔG⁰ᵣₓₙ |
|---|---|---|
| | | (cal/mol) |
| (1) | C₂H₅OH₍₁₎ + 3H₂O₍₁₎ ⇄ 6H_{2(g)} + | 23,950 |
| | 2CO_{2(g)} | |
| (2) | C₂H₅OH₍₁₎ + 2OH⁻ _{(aq)} + 3H₂O₍₁₎ ⇄ | 7,040 |
| | 6H_{2(g)} + 2HCO₃⁻_{(aq)} | |
| (3) | C₂H₅OH₍₁₎ + 4OH⁻ _{(aq)} + H2O₍₁₎ ⇄ | −2,970 |
| | 6H_{2(g)} + 2CO₃²⁻ _{(aq)} | |

Reaction (1) is the conventional reformation reaction of ethanol and reactions (2) and (3) are base-facilitated reformation reactions according to the invention of the '707 patent. In reactions (2) and (3), the hydroxide ion (OH⁻) reactant is provided by a base. Reactions (2) and (3) differ with respect to the relative amounts of hydroxide ion and ethanol. Reaction (2) includes a lower amount of base and proceeds through a bicarbonate ion (HCO₃⁻) by-product, while reaction (3) includes a higher amount of base and proceeds through a carbonate ion (CO₃⁻) by-product.

ΔG⁰ᵣₓₙ is the Gibbs free energy of reaction for each of the reactions at standard conditions (25° C., 1 atm. and unit activity of reactants and products). The Gibbs free energy is an indicator of the thermodynamic spontaneity of a chemical reaction. Spontaneous reactions have negative values for the Gibbs free energy, while non-spontaneous reactions have positive values for the Gibbs free energy. Reaction conditions such as reaction temperature, reaction pressure, concentration etc. may influence the value of the Gibbs free energy. A reaction that is non-spontaneous at one set of conditions may become spontaneous at another set of conditions. The magnitude of the Gibbs free energy is an indicator of the degree of spontaneity of a reaction. The more negative (or less positive) the Gibbs free energy is, the more spontaneous is the reaction.

The reformation reaction (1) above is a non-spontaneous reaction at standard conditions. The base-facilitated reformation reaction (2) is also non-spontaneous, but is more spontaneous than reaction (1) (and would become spontaneous at a lower temperature than reaction (1)). Inclusion of a base creates a reaction pathway for the production of hydrogen from ethanol in a base-facilitated reaction that is less non-spontaneous than the production of hydrogen from the conventional reformation reaction (1) of ethanol. Further addition of base leads to a further decrease in the Gibbs free energy and ultimately provides a spontaneous reaction at standard conditions as exemplified by reaction (3) above. The ability of a base to improve the thermodynamic spontaneity of the production of hydrogen from naturally occurring organic matter is an important beneficial feature of the instant hydrogen producing reactions. The greater thermodynamic spontaneity may enable the spontaneous production of hydrogen from organic matter at a particular set of reaction conditions in a base-facilitated reformation reaction where the conventional reformation reaction at the same conditions is non-spontaneous and therefore unable to produce hydrogen spontaneously.

The instant invention generally is concerned with the production of hydrogen from organic matter in a base-facilitated reformation reaction. More specifically, the instant invention demonstrates the feasibility of using a base to improve the thermodynamic spontaneity of producing hydrogen from organic matter. Of particular interest to the instant inventors is the production of hydrogen from naturally occurring organic matter such as biomass and components thereof. Carbohydrates, including sugars, are preferred reactants in the instant base-facilitated hydrogen production reactions.

Hydrogen can be obtained from the organic components present in biomass through reformation reactions analogous to reaction (1) above. As an example, hydrogen can be produced from glucose (C₆H₁₂O₆) in the following reaction (4):

C₆H₁₂O₆₍ₛ₎+6H₂O₍ₗ₎⇄6CO_{2(g)}12H_{2(g)} (4)

A thermodynamic analysis of this reaction indicates that at standard conditions, ΔG⁰ᵣₓₙ=−8.2 kcal/mol and ΔH⁰ᵣₓₙ=150.2 kcal/mol, where ΔG⁰ᵣₓₙ is the Gibbs free energy of reaction and ΔH⁰ᵣₓₙ is the enthalpy of reaction. The analysis indicates that although the reaction is spontaneous at standard conditions, it is highly endothermic and thus requires a substantial input of energy to perform. In practice, the reformation of glucose according to reaction (4) would require high temperatures to proceed at a reasonable rate.

The thermodynamic analysis of reaction (4) is representative of reformation reactions of organic substances that are analogous to those used in the reformation of simple compounds such as methanol or ethanol. In contrast to methanol and ethanol, however, the carbohydrate and other components of biomass do not withstand high temperatures well due to a tendency to decompose. While it is straightforward to vaporize methanol or ethanol in a high temperature reformation reaction, vaporization of carbohydrates and other biomass components may not be practical due to the relative involatility and potential thermal decomposition of these substances at high temperatures. Reactions such as (4) have been proposed in the steam reforming of bio-oils. We present reaction (4) and analogous reactions for other systems hereinbelow to illustrate the thermodynamic unfavorability of such reactions at standard conditions and to motivate the thermodynamic advantages of the reactions within the scope of the instant invention. Due to the more favorable thermodynamics of the instant reactions relative to conventional-type reformation reactions such as (4), the instant reactions produce hydrogen at less extreme conditions and with faster rates of hydrogen production at a given set of conditions than is the case for the conventional-type reformation reactions.

Under the principles of the instant invention, hydrogen is produced from glucose by reacting it with a base such as sodium hydroxide (NaOH). Depending on the relative proportion of base employed, hydrogen can be produced from glucose through reactions that produce carbonate or bicarbonate salt of the cation present in the base. Representative reactions of glucose with sodium hydroxide that proceed through the formation of sodium carbonate (Na₂CO₃) and sodium bicarbonate (NaHCO₃) are given in reactions (5) and (6), respectively, below:

C₆H₁₂O₆₍ₛ₎+12NaOH_{(aq)}⇄6Na₂CO_{3(aq)}+12H_{2(g)} (5)

C₆H₁₂O₆₍ₛ₎+6NaOH_{(aq)}+6H₂O₍ₗ₎⇄6NaHCO_{3(aq)}+12H_{2(g)} (6)

A thermodynamic analysis of reaction (5) indicates that at standard conditions ΔG⁰ᵣₓₙ=−88.3 kcal/mol and ΔH⁰ᵣₓₙ=−9.9 kcal/mol. The analysis shows that the inclusion of a base in the hydrogen producing reaction leads to a decrease in both the free energy and enthalpy of reaction at standard conditions relative to the reformation reaction (4). The base-facilitated hydrogen producing reaction (5) is more spontaneous than the reformation reaction (4) and at the same time has become exothermic. As a result, the base-facilitated reaction (5) can occur in principle at standard conditions in the liquid phase since no additional input of energy is required.

A thermodynamic analysis of reaction (6) indicates that at standard conditions ΔG⁰ᵣₓₙ=−58.3 kcal/mol and ΔH⁰ᵣₓₙ=50.5 kcal/mol. The analysis shows that the inclusion of a base in the hydrogen producing reaction leads to a decrease in both the free energy and enthalpy of reaction at standard conditions relative to the reformation reaction (4). The base-facilitated hydrogen producing reaction (6) is more spontaneous than the reformation reaction (4), but less spontaneous than the base-facilitated reaction (5). The base-facilitated reaction (6) remains endothermic, but is less endothermic than the reformation reaction (4) and as a result is not expected to proceed at room temperature in the liquid phase without an additional input of energy. Since the base-facilitated reaction (6) is less endothermic than the reformation reaction (4), however, a smaller input of energy is needed for reaction (6) than reaction (4). As a result, the temperature required to operate reaction (6) at practical rates is expected to be much lower than the temperatures required for the performance of the reformation reaction (4). The base-facilitated reaction (6) thus offers a cost advantage over the reformation reaction (4) since less extreme conditions suffice to produce hydrogen at a reasonable rate from reaction (6).

As an example of the production of hydrogen from another carbohydrate, we consider sucrose as a starting material in the instant base-facilitated reactions. Sucrose is a disaccharide having the formula C₁₂H₂₂O₁₁. Hydrogen can be produced from sucrose in a reformation reaction as shown in the following reaction (7):

C₁₂H₂₂O₁₁₍ₛ₎+13H₂O₍ₗ₎⇄12CO_{2(g)}+24H_{2(g)} (7)

A thermodynamic analysis of this reaction indicates that at standard conditions, ΔG⁰ᵣₓₙ=−25.7 kcal/mol and ΔH⁰ᵣₓₙ=291.26 kcal/mol, where ΔG⁰ᵣₓₙ is the Gibbs free energy of reaction and ΔH⁰ᵣₓₙ is the enthalpy of reaction. The analysis indicates that although the reaction is spontaneous at standard conditions, it is highly endothermic and thus requires a substantial input of energy to perform. The high energy input required for the reformation of sucrose according to reaction (7) would require high operating temperatures to proceed at a reasonable rate would likely be impractical due to thermal decomposition of sucrose.

Under the principles of the instant invention, hydrogen is produced from sucrose by reacting it with a base such as sodium hydroxide (NaOH). Depending on the relative proportion of base employed, hydrogen can be produced from sucrose through reactions that produce carbonate or bicarbonate salt of the cation present in the base. Representative reactions of sucrose with sodium hydroxide that proceed through the formation of sodium carbonate (Na₂CO₃) and sodium bicarbonate (NaHCO₃) are given in reactions (8) and (9), respectively, below:

C₁₂H₂₂O₁₁₍ₛ₎+24NaOH_{(aq)}+H₂O₍ₗ₎⇄12Na₂CO_{3(aq)}+24H_{2(g)} (8)

C₁₂H₂₂O₁₁₍ₛ₎+12NaOH_{(aq)}+13H₂O₍ₗ₎⇄12NaHCO_{3(aq)}+24H_{2(g)} (9)

A thermodynamic analysis of reaction (8) indicates that at standard conditions ΔG⁰ᵣₓₙ=−188.9 kcal/mol and ΔH⁰ᵣₓₙ=−32.02 kcal/mol. The analysis shows that the inclusion of a base in the hydrogen producing reaction leads to a decrease in both the free energy and enthalpy of reaction at standard conditions relative to the reformation reaction (7). The base-facilitated hydrogen producing reaction (8) is more spontaneous than the reformation reaction (7) and at the same time has become exothermic. As a result, the base-facilitated reaction (8) can occur in principle at standard conditions in the liquid phase since no additional input of energy is required.

A thermodynamic analysis of reaction (9) indicates that at standard conditions ΔG⁰ᵣₓₙ=−128.18 kcal/mol and ΔH⁰ᵣₓₙ=89.06 kcal/mol. The analysis shows that the inclusion of a base in the hydrogen producing reaction leads to a decrease in both the free energy and enthalpy of reaction at standard conditions relative to the reformation reaction (7). The base-facilitated hydrogen producing reaction (9) is more spontaneous than the reformation reaction (7), but less spontaneous than the base-facilitated reaction (8). The base-facilitated reaction (9) remains endothermic, but is less endothermic than the reformation reaction (7) and as a result is not expected to proceed at room temperature in the liquid phase without an additional input of energy. Since the base-facilitated reaction (9) is less endothermic than the reformation reaction (7), however, a smaller input of energy is needed for reaction (9) than reaction (7). As a result, the temperature required to operate reaction (9) in a practical reactor is expected to be lower than the several hundred degree temperatures that would normally be necessary for the practical performance of the reformation reaction (7). The base-facilitated reaction (9) thus offers a cost advantage over the reformation reaction (7) since less extreme conditions suffice to produce hydrogen at a reasonable rate from reaction (9).

As an example of the production of hydrogen from yet another carbohydrate, we consider mannitol as a starting material in the instant base-facilitated reactions. Mannitol is a reduced form of the sugar mannose and has the formula C₆H₁₄O₆. Hydrogen can be produced from mannitol in a conventional-type reformation reaction as shown in the following reaction (10):

C₆H₁₄O₆₍ₛ₎+6H₂O₍ₗ₎⇄6CO_{2(g)}+13H_{2(g)} (10)

A thermodynamic analysis of this reaction indicates that at standard conditions, ΔG⁰ᵣₓₙ=−4.59 kcal/mol and ΔH⁰ᵣₓₙ=158.34 kcal/mol, where ΔG⁰ᵣₓₙ is the Gibbs free energy of reaction and ΔH⁰ᵣₓₙ is the enthalpy of reaction. The analysis indicates that although the reaction is slightly spontaneous at standard conditions, it is highly endothermic and requires a substantial input of energy to perform. The high energy input required for the reformation of mannitol according to reaction (10) would require operating temperatures of several hundred degrees to produce hydrogen at practical rates.

Under the principles of the instant invention, hydrogen is produced from mannitol by reacting it with a base such as sodium hydroxide (NaOH). Depending on the relative proportion of base employed, hydrogen can be produced from mannitol through reactions that produce carbonate or bicarbonate salt of the cation present in the base. The reactions of mannitol with sodium hydroxide that proceed through the formation of sodium carbonate (Na₂CO₃) and sodium bicarbonate (NaHCO₃) are given in reactions (11) and (12), respectively, below:

C₆H₁₄O₆₍ₛ₎+12NaOH_{(aq)}⇄6Na₂CO_{3(aq)}+13H_{2(g)} (11)

C₆H₁₄O₆₍ₛ₎+6NaOH_{(aq)}+6H₂O₍ₗ₎⇄6NaHCO_{3(aq)}+13H_{2(g)} (12)

A thermodynamic analysis of reaction (11) indicates that at standard conditions ΔG⁰ᵣₓₙ=−86.19 kcal/mol and ΔH⁰ᵣₓₙ=−3.3 kcal/mol. The analysis shows that the inclusion of a base in the hydrogen producing reaction leads to a decrease in both the free energy and enthalpy of reaction at standard conditions relative to the reformation reaction (10). The base-facilitated hydrogen producing reaction (11) is more spontaneous than the reformation reaction (10) and at the same time has become exothermic. As a result, the base-facilitated reaction (11) can occur in principle at standard conditions in the liquid phase since no additional input of energy is required.

A thermodynamic analysis of reaction (12) indicates that at standard conditions ΔG⁰ᵣₓₙ=−55.83 kcal/mol and ΔH⁰ᵣₓₙ=57.24 kcal/mol. The analysis shows that the inclusion of a base in the hydrogen producing reaction leads to a decrease in both the free energy and enthalpy of reaction at standard conditions relative to the reformation reaction (10). The base-facilitated hydrogen producing reaction (12) is more spontaneous than the reformation reaction (10), but less spontaneous than the base-facilitated reaction (11). The base-facilitated reaction (12) remains endothermic, but is less endothermic than the reformation reaction (10) and as a result is not expected to proceed at room temperature in the liquid phase without an additional input of energy. Since the base-facilitated reaction (12) is less endothermic than the reformation reaction (10), however, a smaller input of energy is needed for reaction (12) than reaction (10). As a result, the temperature required to operate reaction (12) in a practical reactor is expected to be lower than the several hundred degree temperatures that would normally be necessary for the performance of the reformation reaction (10). The base-facilitated reaction (12) thus offers a cost advantage over the reformation reaction (10) since less extreme conditions suffice to produce hydrogen at a reasonable rate from reaction (12).

The illustrative embodiments of the instant base-facilitated reactions described hereinabove are representative of reactions according to the instant invention that proceed through a liquid phase form of the base. The instant invention further includes embodiments in which a solid phase base is utilized in the instant reaction and those in which a solid phase carbonate or bicarbonate by-product is produced along with hydrogen gas. Several illustrations of such embodiments are now described.

Reactions (13) and (14) are analogs of reactions (5) and (6), respectively, described hereinabove for the base-facilitated reaction of glucose:

C₆H₁₂O₆₍ₛ₎+12NaOH₍ₛ₎⇄6Na₂CO₃₍ₛ₎+12H_{2(g)} (13)

C₆H₁₂O₆₍ₛ₎+6NaOH₍ₛ₎+6H₂O_{(g)}⇄6NaHCO₃₍ₛ₎+12H_{2(g)} (14)

In reactions (13) and (14), glucose in the solid phase is reacted with solid phase base to form a solid phase carbonate or bicarbonate compound. These reactions occur at the interface of the solid phase reactants and can be completed by layering one solid on top of the other or by grinding or otherwise intimately mixing the two solid starting materials. In the case of reaction (14), water in the vapor phase is included as a reactant and the reaction proceeds in the absence of liquid phase water.

A thermodynamic analysis of reaction (13) indicates that at standard conditions ΔG⁰ᵣₓₙ=−196.9 kcal/mol and ΔH⁰ᵣₓₙ=−96.6 kcal/mol and a thermodynamic analysis of reaction (14) indicates that at standard conditions ΔG⁰ᵣₓₙ=−128.7 kcal/mol and ΔH⁰ᵣₓₙ=−97.3 kcal/mol. As in the case of corresponding reactions (5) and (6), the thermodynamic analysis indicates that reactions (13) and (14) occur spontaneously at standard conditions and further suggests that practical rates of hydrogen production can be achieved at reasonable reaction conditions. The results further indicate that the reaction thermodynamics are more favorable for glucose in the solid phase relative to the liquid phase. The results also show the solid phase reaction (14) that proceeds through the formation of a bicarbonate by-product is exothermic, while the corresponding liquid phase reaction (6) is endothermic.

Reactions (15) and (16) are analogs of reactions (8) and (9), respectively, described hereinabove for the base-facilitated reaction of sucrose:

C₁₂H₂₂O₁₁₍ₛ₎+24NaOH₍ₛ₎+H₂O_{(g)}⇄12Na₂CO₃₍ₛ₎+24H_{2(g)} (15)

C₁₂H₂₂O₁₁₍ₛ₎+12NaOH₍ₛ₎+13H₂O_{(g)}⇄12NaHCO₃₍ₛ₎+24H_{2(g)} (16)

In reactions (15) and (16), sucrose in the solid phase is reacted with solid phase base to form a solid phase carbonate or bicarbonate compound. These reactions occur at the interface of the solid phase reactants and can be completed by layering one solid on top of the other or by grinding or otherwise intimately mixing the two solid starting materials. Water in the vapor phase is included as a reactant in both reactions and the reactions proceed in the absence of liquid phase water.

A thermodynamic analysis of reaction (15) indicates that at standard conditions ΔG⁰ᵣₓₙ=−405.5 kcal/mol and ΔH⁰ᵣₓₙ=−213.4 kcal/mol and a thermodynamic analysis of reaction (16) indicates that at standard conditions ΔG⁰ᵣₓₙ=−269.1 kcal/mol and ΔH⁰ᵣₓₙ=−214.9 kcal/mol. As in the case of corresponding reactions (8) and (9), the thermodynamic analysis indicates that reactions (15) and (16) occur spontaneously at standard conditions and further suggests that practical rates of hydrogen production can be achieved at reasonable reaction conditions. The results further indicate that the reaction thermodynamics are more favorable for sucrose in the solid phase relative to the liquid phase. The results also show the solid phase reaction (16) that proceeds through the formation of a bicarbonate by-product is exothermic, while the corresponding liquid phase reaction (9) is endothermic.

Reactions (17) and (18) are analogs of reactions (11) and (12), respectively, described hereinabove for the base-facilitated reaction mannitol:

C₆H₁₄O₆₍ₛ₎+12NaOH₍ₛ₎⇄6Na₂CO₃₍ₛ₎+13H_{2(g)} (17)

C₆H₁₄O₆₍ₛ₎+6NaOH₍ₛ₎+6H₂O_{(g)}⇄6NaHCO₃₍ₛ₎+13H_{2(g)} (18)

In reactions (17) and (18), mannitol in the solid phase is reacted with solid phase base to form a solid phase carbonate or bicarbonate compound. These reactions occur at the interface of the solid phase reactants and can be completed by layering one solid on top of the other or by grinding or otherwise intimately mixing the two solid starting materials. In the case of reaction (18), water in the vapor phase is included as a reactant and the reaction proceeds in the absence of liquid phase water.

A thermodynamic analysis of reaction (17) indicates that at standard conditions ΔG⁰ᵣₓₙ=−193.5 kcal/mol and ΔH⁰ᵣₓₙ=−88.7 kcal/mol and a thermodynamic analysis of reaction (18) indicates that at standard conditions ΔG⁰ᵣₓₙ=−125.3 kcal/mol and ΔH⁰ᵣₓₙ=−89.5 kcal/mol. As in the case of corresponding reactions (11) and (12), the thermodynamic analysis indicates that reactions (17) and (18) occur spontaneously at standard conditions and further suggests that practical rates of hydrogen production can be achieved at reasonable reaction conditions. The results further indicate that the reaction thermodynamics are more favorable for mannitol in the solid phase relative to the liquid phase. The results also show the solid phase reaction (18) that proceeds through the formation of a bicarbonate by-product is exothermic, while the corresponding liquid phase reaction (12) is endothermic.

Reactions utilizing a solid phase biomass or biomass component and a solid phase base such as those described in reactions (13)-(18) hereinabove may also be conducted at elevated temperatures to increase the rate of production of hydrogen. When elevated temperatures are used, it is preferable to minimize the presence of oxygen in the reaction environment to avoid oxidative thermal decomposition of the organic reactant. As the temperature is elevated, the solid phase base may be transformed into a molten state. The instant invention further includes reactions in which the base reactant is in the molten state.

### Example 1

In this example, the production of hydrogen from a base-facilitated reaction of glucose (C₆H₁₂O₁₂) is demonstrated. 75 g of glucose was combined with 145 g of sodium hydroxide (NaOH), 125 mL of water and a commercial catalyst (20% Pt on C supported on a silver-plated nickel screen) in a 1 L round bottom flask. The flask was sealed and equipped with a pressure gauge. The temperature of the flask was raised to 115° C. and the gas pressure in the headspace of the flask was measured as a function of time.

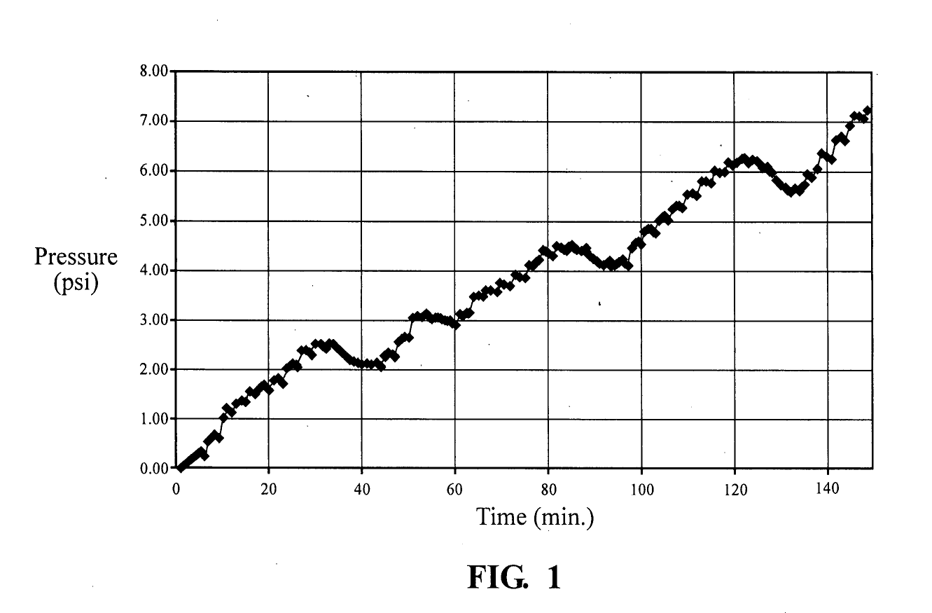

The results of the experiment are shown in FIG. 1 herein where the gauge pressure in psi is reported as a function of reaction time. The results indicate that a steady increase in the pressure of the gas contained in the headspace of the flask occurred with increasing reaction time. After 150 minutes of reaction, an aliquot of the gas produced was analyzed with gas chromatography and was determined to be hydrogen gas.

The results of this experiment indicate that hydrogen can be continually produced in a state of high purity at high reaction rates under reasonable reaction conditions. The 115° C. temperature used in this example is much lower than the temperatures that would be required for the conventional-type reformation reaction (4) of glucose.

The advantages of the base-facilitated production of hydrogen as described hereinabove for glucose, sucrose and mannitol are similarly manifested in base-facilitated reactions of other organic components found in biomass and naturally occurring organic matter. Carbohydrates are the preferred components of biomass for use in the instant invention. The preferred carbohydrates include polyhydroxyaldehydes, polyhydroxyketones and their derivates, including compounds having an empirical formula CₙH₂ₙOₙ where n is an index having an integer value as well as oxidized (acids) and reduced (alcohols) forms of the carbohydrates. Preferably the index n is greater than 2 and more preferably the index n is greater than 5. Carbohydrates suitable for use in the instant base-facilitated reactions for the production of hydrogen include monosaccharides (e.g. glucose, mannose, fructose, arabinose, aldoses, ketoses), disaccharides (e.g. sucrose, lactose, maltose, cellobiose), oligosaccharides (e.g. cellotriose), polysaccharides (e.g. cellulose, starch, lignin) as well as the oxidized and reduced forms thereof. The instant base-facilitated reactions can be performed on biomass directly and processed biomass as well as on individual components or mixtures of the individual components of biomass in a purified or unpurified state.

In one embodiment, hydrogen is produced according to the instant invention from a mixture of two or more carbohydrates. In another embodiment, hydrogen is produced from biomass, where the biomass comprises a carbohydrate. In another embodiment, hydrogen is produced from biomass, where the biomass comprises two or more carbohydrates. In a further embodiment, hydrogen is produced from biomass, where the biomass comprises three or more carbohydrates.

The advantages of the instant base-facilitated reactions are further manifested over a wide range of conditions of temperature, pressure, species concentration etc. By varying reaction parameters, reactions that are spontaneous at standard conditions may become more spontaneous and may occur at faster reaction rates. The greater spontaneity of the instant base-facilitated hydrogen production reactions leads to faster rates of production of hydrogen at common reaction conditions for the instant reactions relative to the corresponding reformation reactions, even at temperatures or other conditions for which the conventional reformation reactions are also spontaneous. Also, if a particular rate of formation of hydrogen is required, that rate can be achieved at less extreme (e.g. at lower temperature) through the instant base-facilitated reactions than through the corresponding conventional reformation reactions.

The rate of production of hydrogen gas is an important consideration of interest to the instant inventors. It is generally preferred to produce hydrogen gas at the fastest rate possible. In addition to influencing the spontaneity of a reaction, it is generally the case that once a reaction is spontaneous, an increase in temperature increases the rate of a reaction. In the instant hydrogen-producing reactions, the rate of hydrogen production increases as the temperature of a spontaneous reformation (conventional or base-facilitated) increases. The greater spontaneity of hydrogen production afforded by the instant base-facilitated reactions means that at a particular reaction temperature, the rate of production of hydrogen is higher for a base-facilitated reaction according to the instant invention than for the corresponding conventional reformation reaction. At temperatures at which a base-facilitated reaction of biomass or a component thereof is spontaneous and the corresponding conventional reformation reaction is non-spontaneous, the rate of production of hydrogen is greater for the base-facilitated reaction than for the conventional reformation reaction. Above a certain temperature, the conventional reformation reaction and the instant base-facilitated reactions of a particular carbohydrate are all spontaneous. Even at temperatures at which the conventional and base-facilitated reactions are all spontaneous, it remains the case that the instant base-facilitated reactions are more spontaneous than the corresponding conventional reformation reaction. At a particular temperature at which the conventional reformation reaction and the instant base-facilitated reactions of a carbohydrate are all spontaneous, the rate of production of hydrogen is greater for the base-facilitated reactions than for the conventional reformation reaction. The beneficial effects of including a base in the instant reaction thus include a decrease in the temperature necessary to render a non-spontaneous reaction spontaneous and a greater rate of production of hydrogen relative to the corresponding conventional reformation reaction at a particular reaction temperature due to the greater spontaneity of the instant base-facilitated reactions.

The thermodynamic spontaneity analysis indicates generally that biomass and carbohydrate reformation reactions become increasingly more spontaneous as the amount of base in the reaction increases. Conventional-type reformation reactions having no base present are less spontaneous than base-facilitated reformation reactions having a low concentration of base present which are less spontaneous than base-facilitated reformation reactions having a high concentration of base present. As a result, the instant base-facilitated reformation reactions become spontaneous at less extreme reaction conditions (e.g. lower reaction temperatures) than the corresponding conventional reformation reactions and further produce hydrogen at faster rates at common conditions. The instant base-facilitated reactions further permit the production of hydrogen while avoiding the simultaneous production of the greenhouse gases CO and CO₂.

In practical operation it is preferable to perform the instant hydrogen-producing reactions at the lowest temperatures possible that produce hydrogen at an acceptable rate. Embodiments of the instant reactions that are spontaneous and endothermic at standard temperature (25° C.) and standard pressure (1 atm) produce hydrogen at those conditions. It may be desirable to raise the temperature to increase the rate of production of hydrogen or to perform the reaction in the reaction with water in the vapor phase. In a preferred embodiment, the reaction temperature is below the decomposition temperature of the biomass or component thereof used as a reactant in the instant reactions. In one embodiment, the reaction temperature is between 25° C. and 100° C. In another embodiment, the reaction temperature is between 100° C. and 200° C.

Metal hydroxides are the preferred bases in the instant reactions. Representative metal hydroxides include alkali metal hydroxides (e.g. NaOH, KOH etc.) alkaline earth metal hydroxides (e.g. Ca(OH)₂, Mg(OH)₂, etc.), transition metal hydroxides, post-transition metal hydroxides and rare earth hydroxides. Non-metal hydroxides such as ammonium hydroxide may also be used. At standard state conditions, most hydroxide compounds are solids and are introduced in solution form as reactants in the instant base-facilitated hydrogen-producing reactions. Aqueous solutions are one preferred solution form of hydroxide compounds. The solid phase is another preferred form of hydroxide compounds. The molten phase is yet another preferred form of hydroxide compounds.

Many of the preferred carbohydrate reactants of the instant invention are soluble in water and an aqueous phase reaction of the carbohydrate with the base is a preferred embodiment. Embodiments that use other solvents or solvent mixtures are further within the scope of the instant invention. Solvents that at least partially dissolve either or both of the carbohydrate reactant and base reactant are preferred. Polar solvents such as alcohols, for example, may be used in the instant invention.

In other preferred embodiments, reaction occurs between a solid phase biomass or biomass component and a solid phase base. In still other preferred embodiments, reaction occurs between a solid phase biomass or biomass component and a molten phase base. In these embodiments, any necessary water may be introduced in vapor phase form in the absence of liquid phase water.

In a further embodiment of the instant invention, the instant base-facilitated reactions are conducted electrochemically to produce hydrogen from biomass and components thereof. As described in the parent '935 application, inclusion of a base in a hydrogen-producing reaction reduces the electrochemical potential (voltage) required to effect the production of hydrogen from an organic substance relative to the production of hydrogen from the corresponding conventional electrochemical reformation reaction. The instant invention further includes electrochemical reactions in accordance with the parent '935 application as applied to the production of hydrogen from organic matter including biomass, components thereof and mixtures of components. In these embodiments, biomass or one or more components thereof and a base are placed in an electrochemical cell having an anode and a cathode and a voltage is applied between the anode and cathode to effect the electrolytic production of hydrogen in an electrochemical reaction in accordance with the '935 application. In a representative embodiment, organic matter and a base are combined with an electrolyte in an electrochemical cell to form an electrochemical system, an anode and cathode are placed into contact with the electrochemical system and the electrochemical reaction is performed by applying a voltage or passing a current between the anode and cathode. In a preferred embodiment, water is included as the electrolyte.

In yet another embodiment of the instant invention, the instant base-facilitated reactions are conducted in combination with the carbonate or bicarbonate recovery reactions discussed in the co-pending parent '093 application. The carbonate or bicarbonate recovery reactions are intended to improve the overall efficiency of the production of hydrogen from organic substances and mixtures thereof. As indicated hereinabove, in the embodiments of the instant base-facilitated reaction, carbonate or bicarbonate compounds are produced as a by-product of the reaction. A carbonate or bicarbonate compound is a side product that needs to be sold as a commodity, utilized, discarded or otherwise dispensed with. In order to improve the efficiency of hydrogen production, it is desirable to recycle or otherwise utilize the carbonate or bicarbonate compound by-product.

The '093 application discusses recovery reactions that may be used to recycle carbonate or bicarbonate by-products. Various reactions are discussed depending on the form of the carbonate or bicarbonate by-product formed in the instant base-facilitated reaction. As an example, if a carbonate by-product is formed as a metal carbonate precipitate, this precipitate can be collected and thermally decomposed to obtain a metal oxide. This metal oxide can subsequently be reacted with water to form a metal hydroxide that can be returned as a base reactant to the instant base-facilitated reaction. As another example, if a carbonate by-product is formed as a metal carbonate that is soluble in the reaction mixture, further reaction with a metal hydroxide may occur where the metal hydroxide is selected so that the carbonate salt of its metal has a low solubility (low Kₛₚ) so that a metathesis reaction occurs to precipitate out a metal carbonate while leaving behind a soluble metal hydroxide that can be used as a base reactant in further runs of the instant base-facilitated reactions. Bicarbonate by-products may be similarly re-utilized. The method of producing hydrogen gas through the instant base-facilitated reformation reactions may thus optionally include additional steps directed at the recycling, conversion or re-utilization of carbonate or bicarbonate by-products in accordance with the '093 application.

The foregoing discussion and description are not meant to be limitations upon the practice of the present invention, but rather illustrative thereof. It is to be appreciated by persons of skill in the art that numerous equivalents of the illustrative embodiments disclosed herein exist. It is the following claims, including all equivalents and obvious variations thereof, in combination with the foregoing disclosure which define the scope of the invention.

We claim:

1. A process for producing hydrogen gas comprising the step of reacting organic matter with a base to form said hydrogen gas.

2. The process of claim 1, wherein said organic matter is biomass.

3. The process of claim 1, wherein organic matter is a carbohydrate.

4. The process of claim 3, wherein said carbohydrate is at least one selected from the group consisting of monosaccharide, disaccharide, oligosaccharide, polysaccharide, cellulose, starch, glucose, and sucrose.

5. The process of claim 3, wherein said carbohydrate is in a reduced form.

6. The process of claim 5, wherein said reduced form is an alcohol.

7. The process of claim 3, wherein said carbohydrate is in an oxidized form.

8. The process of claim 7, wherein said oxidized form is an acid.

9. The process of claim 3, wherein said carbohydrate has the empirical formula CₙH₂ₙOₙ, where n is an index having an integer value.

10. The process of claim 9, wherein the index n is greater than 5.

11. The process of claim 1, wherein said organic matter and said base are reacted in the presence of water in the form of water vapor, liquid water or both

12. The process of claim 1, wherein said organic matter and said base react in the solid phase.

13. The process of claim 1, wherein said reaction step occurs at a temperature between 25 C and 200 C.

14. The process of claim 3, wherein said organic matter comprises two or more carbohydrates.

15. The process of claim 3, wherein said organic matter comprises three or more carbohydrates.

16. The process of claim 1, wherein said reaction step further forms a carbonate or bicarbonate compound.

17. The process of claim 16, further including the step of reacting said carbonate or bicarbonate compound with a metal hydroxide compound.

18. The process of claim 16, wherein said carbonate or bicarbonate compound is formed as a precipitate.

19. The process of claim 18, further including the step of thermally decomposing said carbonate or bicarbonate precipitate, said thermal decomposition step producing a metal oxide.

20. The process of claim 16, wherein said carbonate or bicarbonate compound is in the form of an aqueous salt.

21. The process of claim 1, wherein said base is a metal hydroxide compound.

22. The process of claim 21, wherein said metal hydroxide compound is an alkali metal hydroxide compound.

23. The process of claim 21, wherein said metal hydroxide compound is an alkaline earth metal hydroxide compound.
